(19) United States
(12) Patent Application Publication
(10) Pub. No.: US 2008/0069974 A1
(43) Pub. Date: Mar. 20, 2008

(54) Liquid crystal display panel and fabricating method thereof

(75) Inventor: Dong Cheon Shin, Seoul (KR)

Correspondence Address: BIRCH STEWART KOLASCH & BIRCH, PO BOX 747, FALLS CHURCH, VA, 22040-0747, US

(73) Assignee: LG.PHILIPS LCD CO., LTD.

(21) Appl. No.: 11/812,210

(22) Filed: Jun. 15, 2007

(30) Foreign Application Priority Data
Sep. 20, 2006 (KR) 10-2006-0091393

(51) Int. Cl. C09K 19/00; B05D 5/12

(52) U.S. Cl. 428/1.2; 427/58

(57) ABSTRACT

There is disclosed a liquid crystal display panel and the fabricating method thereof that is adaptive for preventing the deterioration of display quality in a high temperature environment. A liquid crystal display panel according to an embodiment of the present invention includes a lower array substrate and an upper array substrate which face each other with a liquid crystal therebetween; and an alignment film formed in each of the upper array substrate and the lower array substrate for aligning the liquid crystal, wherein the alignment film is formed of polymers where an optically active radical as a functional group is combined into any one of a polybenzoxazole group compound, a polybenzthiazole group compound or a polybenzimidazole group compound.

This application claims the benefit of the Korean Patent Application No. 10-2006-0091393 filed on Sep. 20, 2006, which is hereby incorporated by reference.

### BACKGROUND OF THE INVENTION

1. Field of the Invention

The present invention relates to a liquid crystal display panel, and more particularly to a liquid crystal display panel and a fabricating method thereof that is adaptive for preventing the deterioration of display quality in a high temperature environment.

2. Description of the Related Art

Generally, a liquid crystal display LCD device controls the light transmittance of liquid crystal cells in accordance with video signals, thereby displaying a picture corresponding to the video signal in a liquid crystal display panel where the liquid crystal cells are arranged in a matrix pattern. To this end, the liquid crystal display device includes a liquid crystal display panel where liquid crystal cells are arranged in an active matrix pattern; and drive circuits for driving the liquid crystal display panel.

The liquid crystal display panel has a structure wherein an upper array substrate (or color filter array substrate) comprising a black matrix, a color filter, an upper alignment film and the like and a lower array substrate (or thin film transistor array substrate) comprising a thin film transistor, a pixel electrode, a lower alignment film and the like are bonded together with a liquid crystal therebetween.

Herein, upper and lower alignment films for aligning the liquid crystal are formed by carrying out a rubbing process after spreading an alignment material such as polyimide and the like.

The upper and lower alignment films of the upper and lower array substrates of the liquid crystal display panel of the related art are formed by performing the rubbing process using a rubbing cloth after the alignment material such as polyimide and the like are spread. However, in the case of forming the alignment film by the rubbing process if the alignment material is rubbed in use of the rubbing cloth, there frequently occur instances where static electricity is generated to damage the alignment material or particles are generated to cause defects in the alignment of the liquid crystal. Also, scratches and the like might be generated in the alignment material by the pressure physically applied by the rubbing cloth.

In order to solve the problem of the alignment caused by the rubbing cloth, there has been proposed an optical alignment technique which uses ultraviolet (UV) rays.

FIG. 1 is a structural formula representing a polyimide group polymer which forms an alignment film where an optical alignment can be made.

The polyimide group optical alignment material shown in FIG. 1 has a structure that an optically active radical as a functional group R is combined with the polyimide group polymer 5.

After spreading the alignment material formed of the material shown in FIG. 1, if ultraviolet rays are irradiated thereonto, an isotropic molecule chain structure within the alignment material reacts optically and chemically on light. Accordingly, the isotropic molecule chain structure is changed to an anisotropic molecule chain structure, thereby forming an anisotropic alignment film. The alignment film made by such an optical alignment does not generate any problems in the alignment made with the rubbing cloth.

On the other hand, although a material formed of the polyimide group compound 5 shown in FIG. 1 is relatively good in heat resistance, the material is weak at a high temperature in case that the liquid crystal display device is driven in a high temperature environment. Accordingly, the alignment capability of the liquid crystal by the alignment film is weakened in the high temperature environment, thus there is a problem in that the display quality is deteriorated, e.g., a residual image appears, in case that the liquid crystal display device is driven to realize a picture.

### SUMMARY OF THE INVENTION

Accordingly, it is an object of the present invention to provide a liquid crystal display panel and the fabricating method thereof that is adaptive for preventing the deterioration of display quality in a high temperature environment.

In order to achieve these and other objects of the invention, a liquid crystal display panel according to an aspect of the present invention comprises a lower array substrate and an upper array substrate which face each other with a liquid crystal therebetween; and an alignment film formed in at least one of the upper array substrate and the lower array substrate for aligning the liquid crystal, wherein the alignment film is formed of polymers where an optically active radical as a functional group is combined into any one of a polybenzoxazole group compound, a polybenzthiazole group compound or a polybenzimidazole group compound.

In one embodiment of the present liquid crystal display panel, the polybenzoxazole group compound may be made by a step polymerization of phenylene dicarboxylic acid and diaminobenzendiol dihydrochloride.

In one embodiment of the present liquid crystal display panel, the polybenzthiazole group compound may be made by a step polymerization of phenylene dicarboxylic acid and diaminobenzendithiol dihydrochloride.

In one embodiment of the present liquid crystal display panel, the polybenzimidazole group compound may be made by a step polymerization of phenylene dicarboxylic acid and tetra amine.

In one embodiment of the present liquid crystal display panel, the optically active radical may be a material which can undergo any one reaction of photopolymerization, photoisomerization, photolysis and photo-realignment.

In one embodiment of the present liquid crystal display panel, the photopolymerization reaction material may be any one of a cinnamic acid derivative, a chalcone derivative, a cumarine derivative and a maleimide derivative; the photoisomerization reaction material may be any one of an azo compound and a stilbene compound; the photolysis reaction material may be a cyclobutane and a carbonyl group compound; and the photo-realignment reaction material may be an aromatic ester group compound.

A fabricating method of a liquid crystal display panel having the step of forming upper and lower alignment films which are located with a liquid crystal therebetween to align the liquid crystal, according to another aspect of the present invention forming at least any one of the upper and lower alignment films comprises forming an alignment material of a polybenzoxazole group polymer, a polybenzthiazole group polymer or a polybenzimidazole group polymer which has an optically active radical as a functional group, in each of upper and lower array substrates; and irradiating the alignment material with ultraviolet rays.

In one embodiment of the present fabricating method, forming the alignment material of the polybenzoxazole group polymer comprises: reacting the photoactivator with any one of phenylene dicarboxylic acid and diaminobenzendiol dihydrochloride; and step-polymerizing the phenylene dicarboxylic acid and the diaminobenzendiol dihydrochloride at a temperature of 100° C.-300° C.

In one embodiment of the present fabricating method, forming the alignment material of the polybenzthiazole group polymer comprises: reacting the photoactivator with any one of phenylene dicarboxylic acid and diaminobenzendithiol dihydrochloride; and step-polymerizing the phenylene dicarboxylic acid and the diaminobenzendithiol dihydrochloride at a temperature of 100° C.-300° C.

In one embodiment of the present fabricating method, forming the alignment material of the polybenzimidazole group polymer comprises: reacting the photoactivator with any one of phenylene dicarboxylic acid and tetra amine; and step-polymerizing the phenylene dicarboxylic acid and the tetra amine at a temperature of 100° C.-300° C.

In one embodiment of the present fabricating method, the optically active radical may be a material which can undergo any one reaction of photopolymerization, photoisomerization, photolysis and photo-realignment.

In one embodiment of the present fabricating method, the photopolymerization reaction material may be any one of a cinnamic acid derivative, a chalcone derivative, a cumarine derivative and a maleimide derivative; the photoisomerization reaction material may be any one of an azo compound and a stilbene compound; the photolysis reaction material may be a cyclobutane and a carbonyl group compound; and the photo-realignment reaction material may be an aromatic ester group compound.

### BRIEF DESCRIPTION OF THE DRAWINGS

These and other objects of the invention will be apparent from the following detailed description of the embodiments of the present invention with reference to the accompanying drawings, in which:

FIG. 1 is a structural formula representing a polyimide group polymer of the related art;

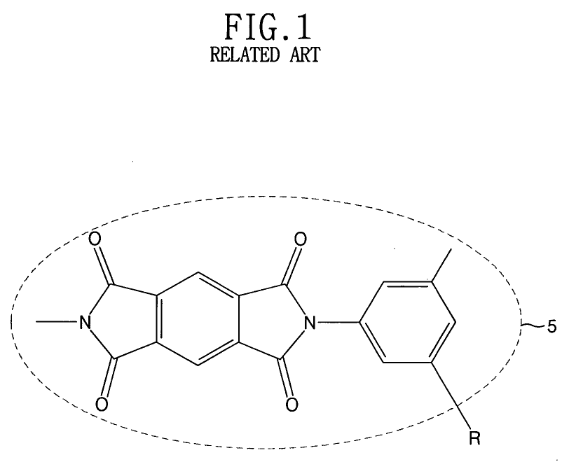

FIG. 2 is a cross sectional diagram representing a liquid crystal display panel according to the present invention;

FIG. 3 is a structural formula representing a polybenzoxazole group polymer according to a first embodiment of the present invention;

FIG. 4 is a diagram representing a fabricating method of the polybenzoxazole group polymer;

FIG. 5 is a structural formula representing a polybenzthiazole group polymer according to a second embodiment of the present invention;

FIG. 6 is a diagram representing a fabricating method of the polybenzthiazole group polymer;

FIG. 7 is a structural formula representing a polybenzimidazole group polymer according to a third embodiment of the present invention; and

FIG. 8 is a diagram representing a fabricating method of the polybenzimidazole group polymer.

### DETAILED DESCRIPTION OF THE PREFERRED EMBODIMENTS

Reference will now be made in detail to the preferred embodiments of the present invention, examples of which are illustrated in the accompanying drawings.

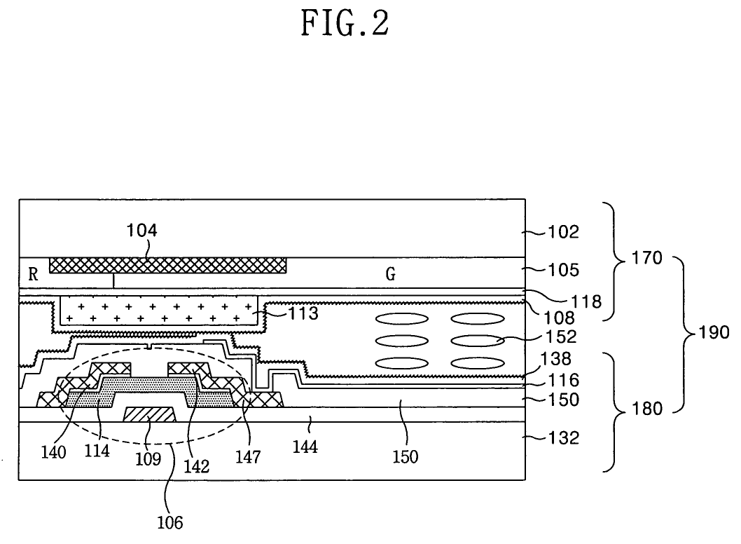

With reference to FIGS. 2 to 8, embodiments of the present invention will be explained as follows.

FIG. 2 is a cross sectional diagram representing a liquid crystal display panel according to the present invention.

Referring to FIG. 2, a liquid crystal display panel 190 includes an upper array substrate (or color filter array substrate) 170 composed of an upper alignment film 108 and a color filter array inclusive of a black matrix 104, a color filter 105 and a common electrode 118 which are sequentially formed on an upper substrate 102; a lower array substrate 180 composed of a lower alignment film 138 and a thin film transistor array inclusive of a thin film transistor TFT 106, a pixel electrode 116 and the like which are formed on a lower substrate 132; a liquid crystal 152 injected into an internal space between the upper array substrate 170 and the lower array substrate 180. On the other hand, the common electrode 118 is formed on the lower substrate 132 in a liquid crystal display panel of IPS mode, and on the color filter 106 of the upper substrate 102 is formed an overcoat layer for compensating a stepped difference of the color filter 106.

In the upper array substrate 170, the black matrix 104 is formed on the upper substrate 102 in correspondence to the areas of gate lines and data lines (not shown) and a TFT 106 area of the lower plate, thereby providing cell areas where the color filters 106 are to be formed. The black matrix 104 prevents light leakage and acts to increase contrast by absorbing an external light at the same time. The color filter 105 is formed to lay over the black matrix 104 and the cell areas divided by the black matrix 104. The color filter 105 is formed for each of R, G, B to realize R, G, B colors. Common voltages for controlling the movement of liquid crystal are supplied to the common electrode 118. Spacers 113 act to maintain a cell gap between the upper array substrate and the lower array substrate.

In the lower array substrate 180, the TFT 106 includes a gate electrode 109 formed on the lower substrate 132 together with the gate line; a semiconductor layer 114, 147 overlapping a gate electrode 109 with a gate insulating film 144 therebetween; and a source/drain electrode 140, 142 formed together with the data line (not shown) with the semiconductor layer 114, 147 therebetween. The TFT 106 supplies pixel signals from the data line to the pixel electrode 116 in response to scan signals from the gate line. The pixel electrode 116 is in contact with a drain electrode 142 of the TFT 106 via a contact hole through pass a passivation film 150, and the passivation film 150 is made of a transparent material which has a high light transmittance.

Upper and lower alignment films (108 and 138, respectively) for aligning liquid crystal are formed of a material of which the heat resistance is better than a polyimide group polymer of the related art.

That is to say, in case the liquid crystal display panel is driven in a high temperature environment, the alignment film is formed in use of the material of which the heat resistance is better than the polyimide group polymer in order to prevent the deterioration of display quality following a liquid crystal alignment capability deterioration. The material with good heat resistance generally has a strong resistance to thermal, mechanical and electrical stress, thus if the alignment film is formed of a material which has better heat resistance, the alignment capability of liquid crystal can be maintained in a normal manner even in a high temperature environment.

This invention provides an alignment film, formed of polymers where an optically active radical is combined into a material which is used as an aerospace material, as a high heat resistance material which could show such an action effect.

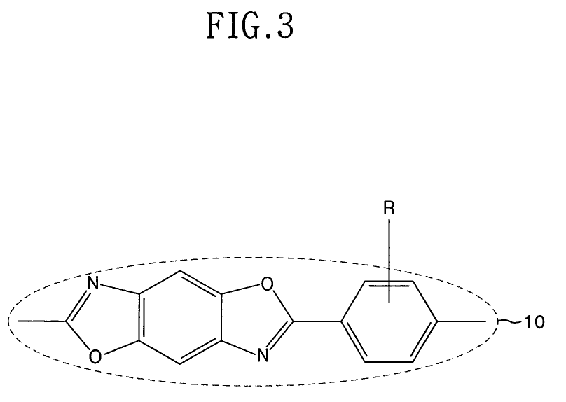

FIG. 3 is a structural formula representing a polybenzoxazole group polymer, where an optically active radical as a functional group R is combined into a polybenzoxazole group compound 10, as an alignment film material according to a first embodiment.

A polybenzoxazole group compound 10 is generally a material of which the heat resistance is better than a polyimide group compound and is used as an aerospace material. The alignment film is formed of a material which is the polybenzoxazole group polymer made by combining the optically active radical for aligning liquid crystal into the polybenzoxazole group compound 10.

The alignment film formed of the polybenzoxazole group polymer is improved in heat resistance when compared with the alignment film formed of the polyimide group polymer of the related art, thus the resistance to mechanical, electrical and thermal stress increases. As a result thereof, even through the liquid crystal display panel is driven in a high temperature environment, the liquid crystal can be controlled in a normal manner, i.e., the liquid crystal is aligned in a normal manner. As a result thereof, the deterioration of display quality is prevented, i.e., the residual image does not appear when realizing the picture.

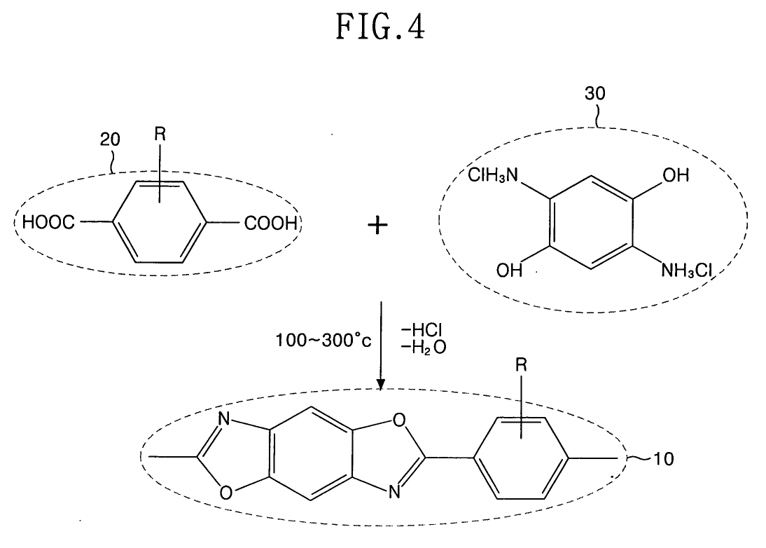

FIG. 4 is a diagram representing a fabricating method of the polybenzoxazole group polymer.

Firstly, the optically active radical as a functional group R is combined into any one of phenylene dicarboxylic acid 20 and diaminobenzendiol dihydrochloride 30 compounds. After that, if the phenylene dicarboxylic acid 20 and diaminobenzendiol dihydrochloride 30 compounds are step-polymerized in an environment of 100° C.-300° C., hydrochloric acid HCl and water H₂O result therefrom to make the polybenzoxazole group polymer 10.

Herein, the optically active radical is a material which can undergo reactions such as photopolymerization, photoisomerization, photolysis, photo-realignment and the like in accordance with photoreaction patterns. For example, the material which can undergo a photopolymerization material might be a cinnamic acid derivative, a chalcone derivative, a cumarine derivative, a maleimide derivative and the like. The material which can undergo the photoisomerization reaction might be an azo compound, a stilbene compound and the like. The material which can undergo the photolysis reaction might be a cyclobutane, a carbonyl group compound and the like. And, the material which can undergo the photo-realignment reaction might be an aromatic ester group compound and the like.

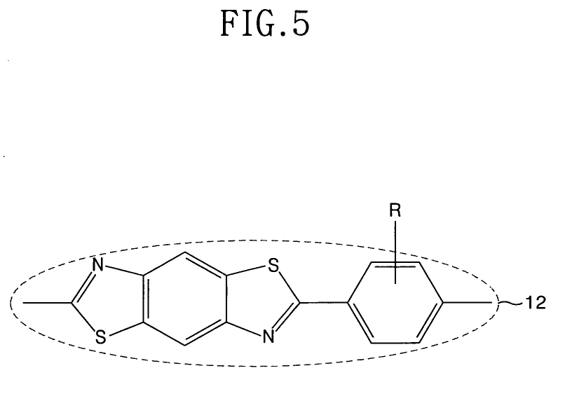

FIG. 5 is a structural formula representing a polybenzthiazole group polymer, where an optically active radical as a functional group R is combined into a polybenzthiazole group compound 12, as an alignment film material according to a second embodiment.

A polybenzthiazole group compound 12 is also a material of which the heat resistance is better than a polyimide group compound and is used as an aerospace material. The polybenzthiazole group compound 12 also has similar characteristic and function to the polybenzoxazole group compound which is proposed in the first embodiment. Accordingly, the alignment film formed of the polybenzthiazole group polymer also has heat resistance and high resistance to mechanical, electrical and thermal stress. Accordingly, if the alignment film of the polybenzthiazole group polymer is formed in the liquid crystal display panel, the liquid crystal can be controlled in the normal manner even though the liquid crystal display panel is driven in a high temperature environment. As a result thereof, the deterioration of display quality is prevented.

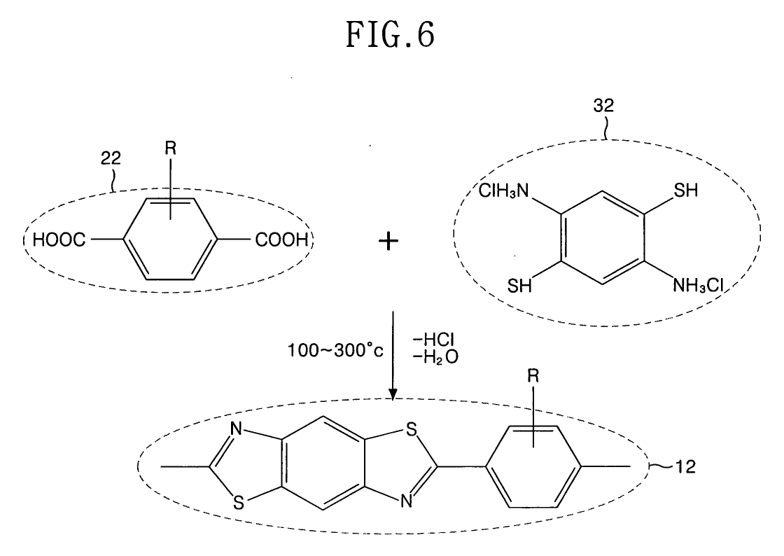

FIG. 6 is a diagram representing a fabricating method of the polybenzthiazole group polymer.

Firstly, the optically active radical as a functional group R is combined into any one of phenylene dicarboxylic acid 22 and diaminobenzendithiol dihydrochloride 32 compounds. After that, if the phenylene dicarboxylic acid 22 and diaminobenzendithiol dihydrochloride 32 compounds are step-polymerized in an environment of 100° C.-300° C., hydrochloric acid HCl and water H₂O result therefrom to make the polybenzthiazole group polymer.

Herein, the optically active radical might be any of the materials listed in the first embodiment.

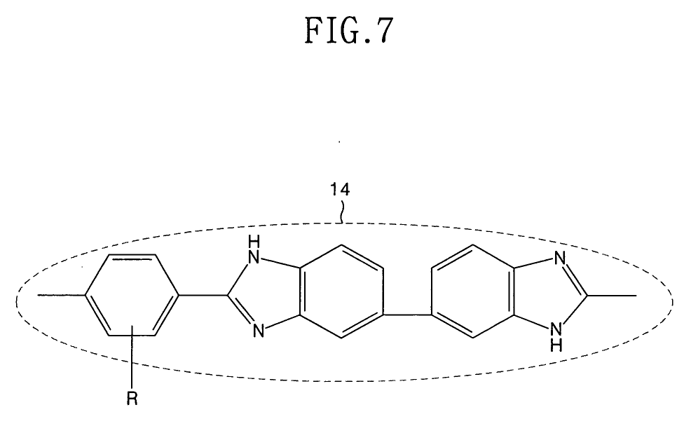

FIG. 7 is a structural formula representing a polybenzimidazole group polymer, where an optically active radical as a functional group R is combined into a polybenzimidazole group compound 14, as an alignment film material according to a third embodiment.

A polybenzimidazole group compound 14 is also a material of which the heat resistance is better than a polyimide group compound and is used as an aerospace material. The polybenzimidazole group compound 14 also has similar characteristic and function to the polybenzoxazole group compound which is proposed in the first embodiment. Accordingly, the alignment film formed of the polybenzimidazole group polymer also has the heat resistance and high resistance to mechanical, electrical and thermal stress. Accordingly, it is possible to achieve the same purpose and effect as the alignment film formed in use of the polybenzthiazole group polymer and the like.

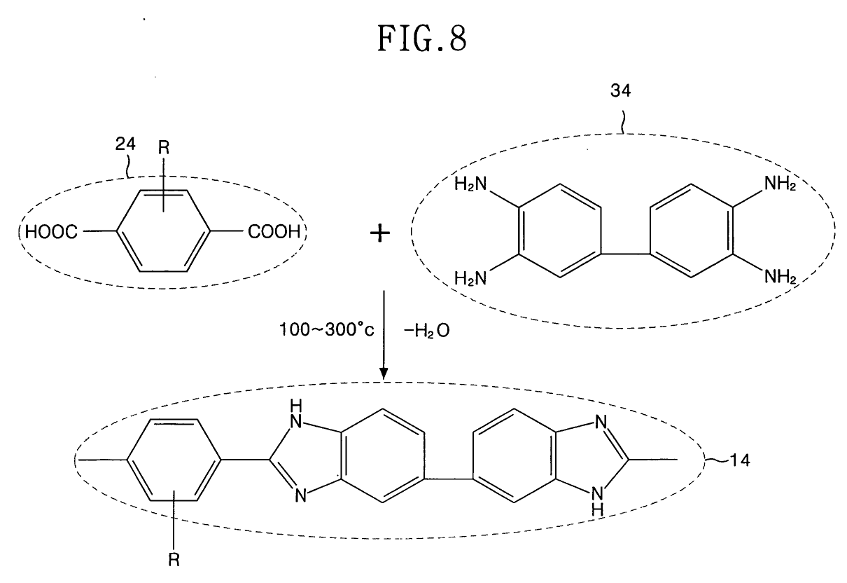

FIG. 8 is a diagram representing a fabricating method of the polybenzimidazole group polymer.

Firstly, the optically active radical as a functional group R is combined into any one of phenylene dicarboxylic acid 24 and tetra amine 34 compounds. After that, if the phenylene dicarboxylic acid 24 and tetra amine 34 compounds are step-polymerized in an environment of 100° C.-300° C., water H₂O results therefrom to make the polybenzimidazole group polymer.

Herein, the optically active radical might be any of the materials listed in the first embodiment.

The alignment material proposed in the first to third embodiments is spread over the upper array substrate where the color filter array is formed and the lower array substrate where the thin film transistor array is formed. After that, ultraviolet rays are irradiated thereon, the molecule chain structure of the polymers within the alignment material is changed by the photochemical reaction caused by the ultraviolet rays, thereby making it possible to form a photo-alignment film.

In this way, the method of forming the alignment film using the alignment material described in the first to third embodiments can be applied not only to a liquid crystal display panel of IPS mode or TN mode, but can also be applied to a liquid crystal display panel of ECB (electrically controlled birefringence) mode, and further to a liquid crystal display panel of VA (vertical alignment) mode.

As described above, the liquid crystal display panel and the fabricating method thereof according to the present invention use an alignment material formed of a polybenzoxazole group polymer, a polybenzthiazole group polymer or a polybenzimidazole group polymer which is good in heat resistance, thereby forming the alignment film of the liquid crystal display panel.

As a result thereof, even though the liquid crystal display panel is driven in a high temperature environment, the liquid crystal can be controlled in the normal manner by the alignment film of which the heat resistance is improved. As a result thereof, the deterioration of display quality is prevented, i.e., the residual image does not appear, when realizing the picture.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A liquid crystal display panel, comprising:
a lower array substrate and an upper array substrate which face each other with a liquid crystal therebetween; and
an alignment film formed in at least one of the upper array substrate and the lower array substrate for aligning the liquid crystal,
wherein the alignment film is formed of a polymer having an optically active radical as a functional group, wherein said polymer is formed from any one of a polybenzoxazole group compound, a polybenzthiazole group compound or a polybenzimidazole group compound.

2. The liquid crystal display panel according to claim 1, wherein the polybenzoxazole group compound is made by a step polymerization of phenylene dicarboxylic acid and diaminobenzendiol dihydrochloride.

3. The liquid crystal display panel according to claim 1, wherein the polybenzthiazole group compound is made by a step polymerization of phenylene dicarboxylic acid and diaminobenzendithiol dihydrochloride.

4. The liquid crystal display panel according to claim 1, wherein the polybenzimidazole group compound is made by a step polymerization of phenylene dicarboxylic acid and tetra amine.

5. The liquid crystal display panel according to claim 1, wherein the optically active radical is a material which can undergo a reaction selected from the group consisting of photopolymerization, photoisomerization, photolysis and photo-realignment.

6. The liquid crystal display panel according to claim 5, wherein
said photopolymerization reaction material is any one of a cinnamic acid derivative, a chalcone derivative, a cumarine derivative and a maleimide derivative;
said photoisomerization reaction material is any one of an azo compound and a stilbene compound;
said photolysis reaction material is any one of a cyclobutane and a carbonyl group compound; and
said photo-realignment reaction material is an aromatic ester group compound.

7. A fabricating method of a liquid crystal display panel having a step of forming upper and lower alignment films which are located with a liquid crystal therebetween and said alignment films align the liquid crystal, comprising:
forming at least one of the upper and lower alignment films, wherein said alignment films are formed from an alignment material comprising a polymer having an optically active radical as a functional group, wherein said polymer is formed from any one of a polybenzoxazole group compound, a polybenzthiazole group compound or a polybenzimidazole group compound, in each of an upper and a lower array substrate; and
irradiating the alignment material with ultraviolet rays.

8. The fabricating method according to claim 7, wherein said alignment material of the polybenzoxazole group polymer is formed by the method comprising:
reacting a photoactivator with any one of phenylene dicarboxylic acid and diaminobenzendiol dihydrochloride; and
step-polymerizing the phenylene dicarboxylic acid and the diaminobenzendiol dihydrochloride at a temperature of 100° C.-300° C.

9. The fabricating method according to claim 7, wherein said alignment material of the polybenzthiazole group polymer is formed by the method comprising:
reacting a photoactivator with any one of phenylene dicarboxylic acid and diaminobenzendithiol dihydrochloride; and
step-polymerizing the phenylene dicarboxylic acid and the diaminobenzendithiol dihydrochloride at a temperature of 100° C.-300° C.

10. The fabricating method according to claim 7, wherein said alignment material of the polybenzimidazole group polymer is formed by the method comprising:
reacting a photoactivator with any one of phenylene dicarboxylic acid and tetra amine; and
step-polymerizing the phenylene dicarboxylic acid and the tetra amine at a temperature of 100° C.-300° C.

11. The fabricating method according to claim 7, wherein the optically active radical is a material which can undergo a reaction selected from the group consisting of photopolymerization, photoisomerization, photolysis and photo-realignment.

12. The fabricating method according to claim 11, wherein
said photopolymerization reaction material is any one of a cinnamic acid derivative, a chalcone derivative, a cumarine derivative and a maleimide derivative;
said photoisomerization reaction material is any one of an azo compound and a stilbene compound;
said photolysis reaction material is any one of a cyclobutane and a carbonyl group compound; and
said photo-realignment reaction material is an aromatic ester group compound.

13. The liquid crystal display panel according to claim 1, wherein said polymer having an optically active radical as a functional group is selected from group consisting of: 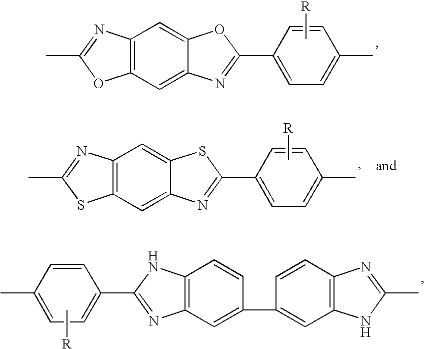
wherein R is said optically active radical as a functional group.

14. The fabricating method according to claim 7 wherein said polymer having an optically active radical as a functional group is selected from group consisting of: 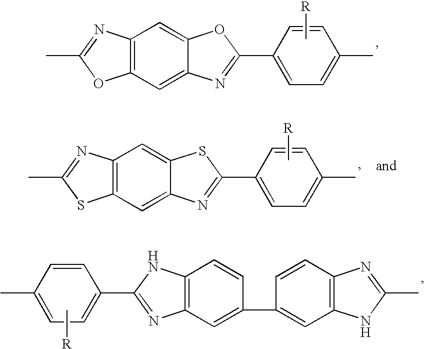
wherein R is said optically active radical as a functional group.
